(19) United States
(12) Patent Application Publication
(10) Pub. No.: US 2011/0290886 A1
(43) Pub. Date: Dec. 1, 2011

(54) IMAGING BAR CODE READER HAVING VARIABLE APERTURE

(75) Inventor: Bradley S. Carlson, Huntington, NY (US)

(73) Assignee: Symbol Technologies, Inc., Holtsville, NY (US)

(21) Appl. No.: 12/788,449

(22) Filed: May 27, 2010

(51) Int. Cl. G06K 7/10

(52) U.S. Cl. 235/462.24

(57) ABSTRACT

The exemplary bar code reader has an auto-focusing component positioned between a photo-detector array and an object having target indicia. The auto-focusing component has a lens system for focusing the target indicia at an imaging plane that generally co-incides with a plane of the photo-detector array. An electromagnetic coil actuator is coupled to an adjustable aperture such that activation of the coil actuator moves the adjustable aperture into and out of the imaging field of view to adjust a focusing on the target indicia. The autofocus component is fixed when the moveable aperture is within the field of view for focusing on objects close to the reader and when the aperture is removed, the autofocus is effective in imaging objects at a greater distance from the reader.

### TECHNICAL FIELD

The present disclosure relates to a system comprising a method and apparatus for improving an imaging quality in an imaging bar code reader.

### BACKGROUND

Existing portable barcode readers may be hand held so they can be moved with respect to a target barcode, to image and decode the bar code. Target objects, e.g., a product package that includes a target barcode, are brought within a field-of-view (“FOV”) of the barcode reader by aiming a visible aiming pattern to strike the package at a region of the barcode. In stationary bar code readers the situation is reversed, i.e. the product is moved through a stationary field of view. The barcode reader typically provides an audible and/or visual signal to indicate the target barcode has been successfully imaged and decoded.

Both stationary and portable imaging-based barcode readers include at least one camera. The camera has an array of photosensitive elements such as a charge coupled device (CCD) or a complementary metal oxide semiconductor (CMOS) device. The bar code reader also typically includes an illumination system that directs illumination toward a target object, e.g., a target bar code. Light reflected from the target bar code is focused through a lens of the camera by an imaging system such that focused light is concentrated onto the array of photosensitive elements. Picture elements or pixels of the array are sequentially read out by the scan engine, generating an analog signal representative of a captured image frame. The analog signal is amplified by a gain factor and the amplified analog signal is digitized by an analog-to-digital converter. Decoding circuitry and/or software of the bar code reader processes the digitized signals and decodes the imaged bar code.

Some existing bar code readers include an autofocus lens system in their imaging camera. These autofocus lens systems are most useful for imaging at far distances. They typically use a relatively large fixed size aperture that lets in more light which is useful for imaging at large distances. These prior art autofocus systems have a fixed size aperture and the depth of field is reduced as the camera focuses on objects more closely positioned with respect to the camera. The travel distance of the lens increases exponentially with decreasing distance to the target to be imaged, so the time to focus on objects close to the camera is longer.

### SUMMARY

An exemplary imaging system improves the quality of images captured by an image based bar code reader. The bar code reader acquires an image within a bar code reader field of view so that a controller can identify a bar code within that field of view.

The exemplary imaging system includes a light source for illuminating a target indicia on an object and a photo-detector array that receives light reflected from the object in a region of the target indicia.

An auto-focusing component is positioned between the photo-detector array and the object. The auto-focusing component has a lens system for focusing the target indicia at an imaging plane that generally co-incides with a plane of the photo-detector array. An electromagnetic drive is coupled to a moveable aperture. Activation of the electromagnetic drive provides controlled movement of the adjustable aperture within the imaging field of view to adjust a depth of field of an image of the target indicia.

In an exemplary embodiment of the disclosed system an electromagnetic coil actuator moves an aperture in and out of the optical path. The autofocusing component uses a large aperture and a small aperture is selectively moved in place by the coil actuator. In one embodiment, if the target object is at a near distance, the small aperture is moved into place enabling large depth of field and the lens position is fixed. With a fixed lens position and small aperture, the camera is configured best for near distance imaging. When the target is at a far distance, the small aperture is moved out of the optical path and the autofocus component is enabled. The large aperture enables the collection of more light that is needed at a far distance, and the lens travel at far distances is small. Thus the camera has the best characteristics for distance imaging.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a perspective view of a portable scanner having at least one camera for imaging a target object;

FIG. 2 is a block diagram of the portable scanner shown in FIG. 1; and

FIGS. 3A and 3B schematically depict imaging optical paths used with an exemplary system at different imaging ranges.

### DETAILED DESCRIPTION

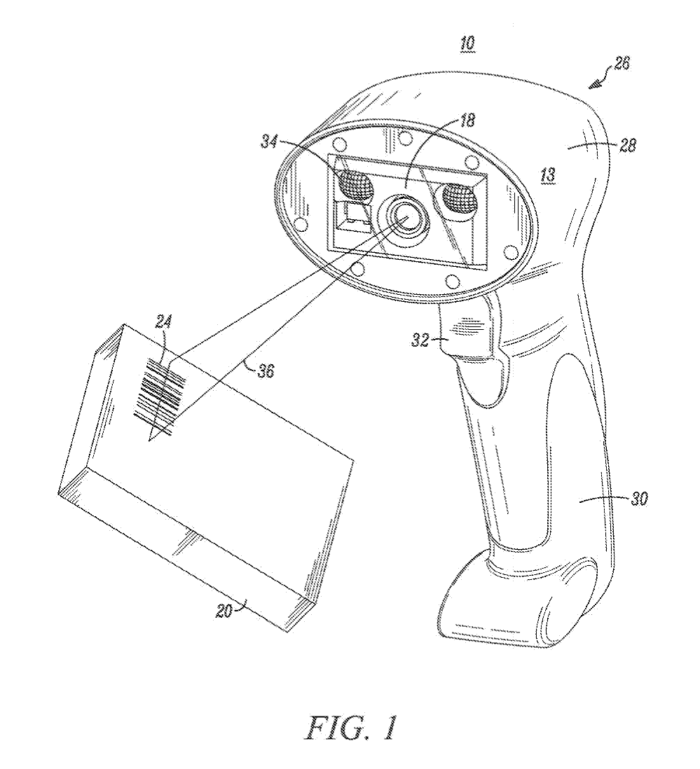

The present disclosure relates to a system for improving image quality in a bar code reader. In one example embodiment illustrated in FIG. 1, an imaging system 10 comprises a hand held portable reader 26 that can be carried. One use of the imaging system 10 is by a user walking or riding through a store, warehouse, or plant, while reading various symbology codes for stocking and inventory control purposes. The reader 26 of FIG. 1 includes a housing 13 having a head 28, handle 30, and trigger 32. Located in the housing is a protective window 34 for protecting an imaging subsystem 18.

The imaging subsystem 18 projects an aiming pattern 36 toward a target bar code 24 located on a product 20 or product's packaging during operation for decoding the bar code in the image of the target object. The operation of the decoding of the bar code by the imaging system 18 is well known in the prior art.

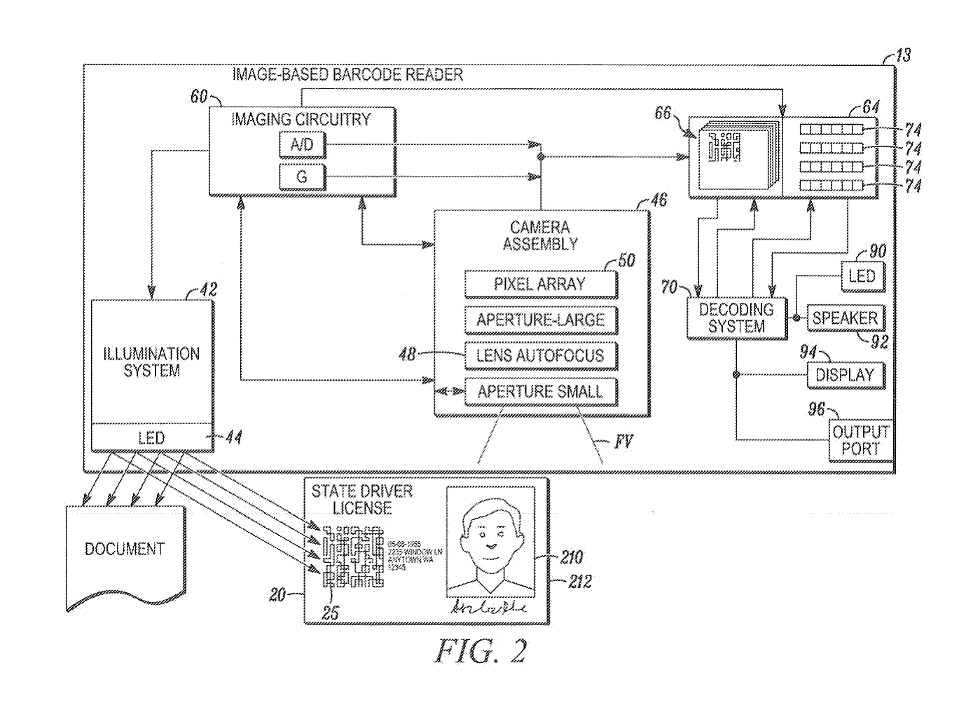

The imaging subsystem 18 has several optical components (FIG. 2) that include, illumination optics 42, aiming optics 44 for generating the aiming pattern 36, and imaging optics 46. Each of the optical components have a designed field-of-view for projecting or receiving light directed during operation at the target object 20. The imaging optics 46 includes a focusing lens or lenses 48 that focus the reflected image from the target object 24 onto a sensor array 50 located behind the focusing lens(es). The aiming optics 44 include a refractive or diffractive optical element that facilitates in the projection of an aiming pattern 36 for aligning the imaging optics for capturing an image that contains the bar code 24. The object 20 shown in FIG. 1 includes a 1D barcode 24 and a 2D bar code is shown on the object 20 in FIG. 2.

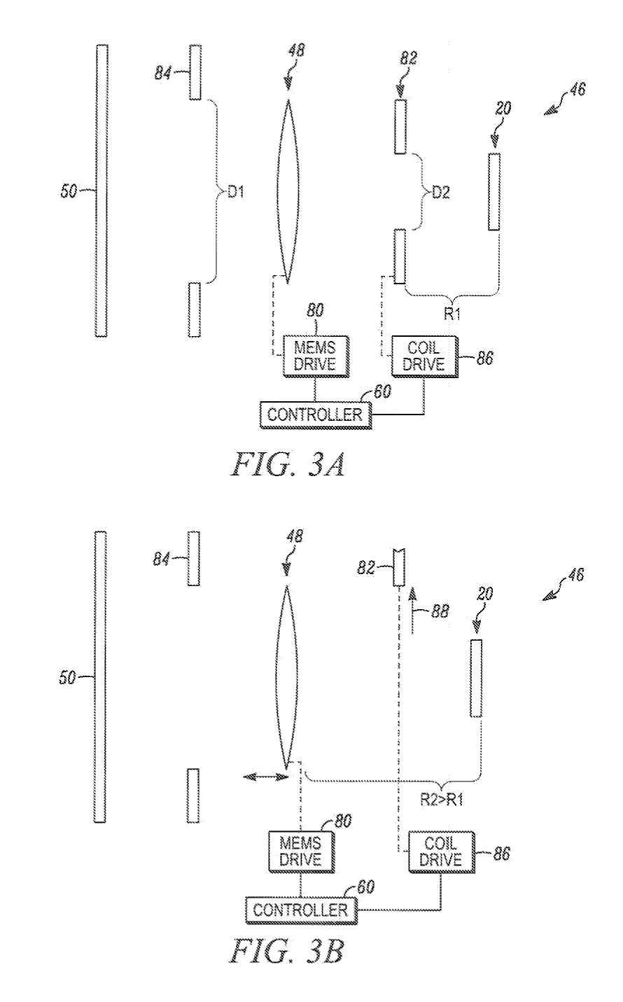

When enabled by a controller 60 (FIG. 3), the imaging optics 46 captures an image frame of a field of view FV of the imaging system. When imaging a target bar code 24, 25, the imaging process may need to capture and store in a memory 64 a series of image frames 66 (FIG. 3) in response to multiple user actuations of the trigger. A decoding system 70 analyzes each image frame of the series of image frames 66 and attempts to decode the imaged bar code. All or portions of the images may be stored in the memory 64 based as results 72 of this decoding. Alternately, the results 72 may be the contents in ascii form of the barcode as interpreted by the decoding system 70.

As depicted in FIG. 2, the imaging optics 46 is coupled to the controller 60. The imaging optics 46 includes a housing supporting focusing optics including a focusing lens 48 and a 2D photosensor or pixel array 50. The imaging optics 46 is enabled during an imaging session to capture images of the field of view FV of the focusing lens 48 and that make up the image frames 124.

Auto-focusing is achieved by controlled movement of one or more lenses 48 positioned between the photo-detector array 50 and the object 20. In the exemplary system autofocus is achieved by a micro-electromechanical or MEMS device or drive 80 coupled to the lens or lenses 48. The camera assembly 46 also includes two apertures 82, 84 for controlling light transmission from the object to the sensor array 50. An adjustable or moveable aperture 82 is coupled to a coil drive 86 and in the exemplary embodiment is moved into and out of an imaging field of view to adjust a depth of field of an image of the target indicia, principally with the object located in a near range of imaging distances such as R1 (typically having a range of 4 to 20 inches) shown in FIG. 3B.

The exemplary actuator for moving the aperture 82 has a coil attached to the MEMs device 80. The moving aperture actuator is a coil that surrounds a housing for the lens 48 (several millimeters in diameter). When the coil is energized in one direction or sense the magnetic field set up by the energized coil moves a plate (not shown) supporting the aperture 82 along a linear path 88 away from one magnet into proximity to a second magnet. When the coil is energized in the opposite direction, the aperture moves back to its original position.

With a fixed position of the lens or lenses 48 and small aperture 82 (about 7 millimeters diameter) within the camera field of view the camera is configured best for near distance imaging. When the target is at a far distance (typical range of 2-50 feet), the small aperture 82 is moved out of the optical path and the autofocus is enabled. The large aperture 84 (about 1.2 millimeters in diameter) enables the collection of more light that is needed at a far distance, and the lens travel at far distances is small. Thus the camera has the best characteristics for distance imaging.

A range finder is able to determine a distance between the object and the reader 10. The range finder is implemented in one of three ways. The MEMs autofocus device 80 has a capacitive signal feedback system that allows the controller 60 to determine where the autofocus is attempting to image an object. When the lens position indicates the autofocus is attempting to focus at a near distance, the autofocus is disabled and the moveable aperture positioned within the field of view. A second alternative is to use the aiming pattern 36 for determining object distance. The source for the aiming pattern is offset from the imaging optical axis. Images of the aiming pattern can be obtained by the controller and evaluated to determine the object spacing from the bar code reader. For objects close to the reader the moveable aperture is moved into the field of view and the autofocus is disabled. A third option is to provide a user actuatable switch or control that sends a signal to the controller, causing the controller to configure the reader for either far field or close in imaging.

A suitable MEMs device 80 is commercially available from Tessera Corporation having a place of business in Arcadia, Calif. under part number SF23XS.

The bar code reader circuitry within the housing 13 is electrically coupled to a power supply, which may be in the form of an on-board battery or a connected off-board power supply. If powered by an on-board battery, the reader 10 may be a stand-alone, portable unit as depicted in FIG. 1. If powered by an off-board power supply, the reader 10 may have some or all of the reader's functionality provided by a connected host device. Circuitry associated with the imaging and decoding systems may be embodied in hardware, software, firmware, electrical circuitry or any combination thereof and may be disposed within, partially within, or external to the reader housing 13.

The sensor array 50 may comprise a charged coupled device (CCD), a complementary metal oxide semiconductor (CMOS), or other imaging pixel array, operating under the control of the imaging circuitry 24. In one exemplary embodiment, the pixel array 50 comprises a two dimensional (2D) mega pixel array with a typical size of the pixel array being on the order of 1280×1024 pixels.

During an imaging session, multiple images of the field of view FV may be obtained by the imaging system 10. An imaging session may be instituted by an operator, for example, pressing the trigger 32 to institute an imaging. Alternately, for a stationary imaging system, an imaging session might start when a lower or bottom edge of an item begin to move through a portion of the field of view FV. After an exposure period, some or all of the pixels of pixel array 50 are successively read out by the controller 60, thereby generating an analog signal which is converted by an analog to digital converter that forms part of the controller 60. In some sensors, particularly CMOS sensors, all pixels of the pixel array 50 are not exposed at the same time, thus, reading out of some pixels may coincide in time with an exposure period for some other pixels.

The analog image signal represents a sequence of photosensor voltage values, the magnitude of each value representing an intensity of the reflected light received by a photosensor/pixel during an exposure period. The analog signal from the array 150 is amplified by a gain factor, generating an amplified analog signal. The amplified analog signal is digitized by an A/D converter generating a digitized signal. The digitized signal comprises a sequence of digital gray scale values typically ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

Successful decoding of the indicia, typically a bar code, can be accompanied by user or machine perceptible outputs from the reader 26. To achieve such notification the reader 26 includes a light emitting diode 90, speaker 92 and display 94. Successful decoding may also be accompanied by signal transmissions via an output port 96 to other devices using a communication protocol.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. An image based bar code reader comprising:
a light source for illuminating target indicia on an object during operation of the bar code reader;
a photo-detector array that receives light reflected from the object in a region of the target indicia during operation of the bar code reader;
an auto-focusing component positioned between the photo-detector array and the object having an imaging field of view, said auto-focusing component including a lens system for focusing the target indicia at an imaging plane that generally co-incides with a plane of the photo-detector array; and
a moveable aperture for controlling light transmission from the object to the photo-detector array and an electromagnetic drive coupled to said moveable aperture to apply controlled movement to the moveable aperture within the imaging field of view and thereby adjust a depth of field of an image of the target indicia.

2. The bar code reader of claim 1 wherein the electromagnetic drive comprises a coil actuator that moves the moveable aperture due to interaction with a magnet supported by the auto-focusing component.

3. The bar code reader of claim 1 wherein the auto-focusing component includes a fixed size entrance aperture and the lens system comprises one or more moving lenses that provide an in-focus image of the target indicia on objects spaced from the imaging system within an image range of the bar code reader.

4. The bar code reader of claim 3 wherein the drive moves the moveable aperture in and out of the field of view and the autofocus component fixes a lens configuration when the aperture is within the field of view.

5. The bar code reader of claim 3 where the moveable aperture restricts an amount of light entering the entrance aperture to increase a depth of field at the imaging plane for objects within the imaging range relatively close to the moveable aperture.

6. The bar code reader of claim 1 wherein the electromagnetic drive includes a linear actuator and wherein movement of the moveable aperture is in a transverse direction to move the moveable aperture into and out of the imaging field of view.

7. The bar code reader of claim 6 wherein the electromagnetic drive moves the moveable aperture into and out of the imaging field of view and further comprising a controller coupled to the autofocus component to adjust the lens system when the moveable aperture is within the field of view.

8. The bar code reader of claim 7 wherein the controller fixes the lens system in one configuration when the moveable lens is within the field of view.

9. The bar code reader of claim 1 additionally comprising a control for interpreting the indicia on the object.

10. A method for imaging a target indicia on an object comprising:
illuminating a target indicia with a light source;
placing a photo-detector for sensing reflected light from the target indicia at an imaging plane;
coupling an adjustable aperture to a drive for controlled movement within an imaging field of view that extends between the object and the photo-detector;
positioning an autofocus component having one or more moving lenses between the adjustable aperture and the photo-detector; and
controlling light transmission from the object reaching the photo-detector by control of the adjustable aperture and/or the autofocus component to focus indicia on the photo-detector over a range of imaging distances.

11. The method of claim 10 wherein the autofocus component has an entrance aperture that is fixed and the adjustable aperture is moved into and out of the imaging field of view by an electromagnetic drive to selectively control light that passes through the entrance aperture of said autofocus component.

12. The method of claim 10 wherein the focusing is controlled by the autofocus component at long imaging distances and wherein the adjustable aperture defines a fixed diameter light transmission opening that is moved into the optical path and wherein the autofocus component is fixed at one focusing configuration at shorter imaging distances.

13. The method of claim 12 wherein the longer imaging distances are in a range of 2 to 50 feet and wherein the shorter imaging distances are in a range of 4 to 20 inches.

14. The method of claim 11 additionally comprising storing digital information related to light reaching the photo-detector to capture an image of the target indicia.

15. An imaging-based bar code reader for imaging target objects, the imaging based bar code reader comprising:
a housing supporting one or more transparent protective windows, the housing and one or more transparent protective windows defining an interior region; and
at least one imager located within said interior region, the imager comprising illumination and imaging optics, the illumination and imaging optics forming a field of view for imaging a target object and target indicia on the object within the field of view and a photo-detector array;
an auto-focusing component positioned in the interior region of the housing between the photo-detector array and the object having a imaging field of view, said auto-focusing component including one or more lenses moveable along an optical path for focusing the target indicia at an imaging plane that generally co-incides with a plane of the photo-detector array;
an aperture having a first diameter fixed between the auto-focusing component and the photo-detector array; and
an electromagnetic actuator coupled to an adjustable aperture such that activation of the actuator provides controlled movement of the adjustable aperture within the imaging field of view for controlling light transmission from the object to the photo-detector array.

16. The imaging-based bar code reader of claim 15 wherein the electromagnetic actuator moves the adjustable aperture into and out of the field of view along a generally linear path.

17. The imaging based bar code reader of claim 16 additionally comprising a controller for moving the aperture into the field of view and fixing the autofocus component for closely spaced objects.

18. The imaging based bar code reader of claim 17 wherein the controller responds to a user input indicating the object is in a closely spaced position with respect to the bar code reader.
